(19) United States
(12) Patent Application Publication
(10) Pub. No.: US 2010/0279655 A1
(43) Pub. Date: Nov. 4, 2010

(54) METHOD OF REMOTE MANAGING ON-CARD GENERATION OF KEYS ON SIM CARDS

(75) Inventor: Thomas Larsson, Alvsjo (SE)

Correspondence Address: YOUNG & THOMPSON, 209 Madison Street, Suite 500, Alexandria, VA, 22314, US

(73) Assignee: SMARTTRUST AB, Stockholm (SE)

(21) Appl. No.: 12/435,613

(22) Filed: May 5, 2009

(30) Foreign Application Priority Data
May 4, 2009 (SE) 0950296-4

(51) Int. Cl. H04M 1/66

(52) U.S. Cl. 455/411

(57) ABSTRACT

Method of remote managing on-card generation of keys on SIM cards from a central OTA system, which OTA system has information about the identity of the SIM card, a first key KO stored on the SIM card, which first key is not readable from the SIM card, and a key generation algorithm stored on the SIM card. The central OTA system is caused to generate a piece of data D by a first algorithm D=f(K0,K1), where K1 is a key that shall be stored on the SIM card, the data D is transferred to the SIM card with OTA technology, an application on the SIM card is caused to make a calculation according to a second algorithm K1=F(K0,D) to generate the desired key K1 and K1 is stored on the SIM card.

The present invention relates to a method of remote managing on-card generation of keys on SIM cards.

The method of remote manage the on-card generation of keys, allows an operator of a telecommunication network for GSM or any other communication standard to remotely manage SIM cards and their sensitive subscription data for the purpose of ODA and machine-to-machine applications.

A SIM card contains several keys, that are used in very sensitive authentications and authorizations procedures, e.g. to attach to a GSM mobile network or authenticate a person or bank transaction. Most of the content of the SIM card may be managed remotely from a central system by standardized over-the-air (OTA) functionality. However, one may not change some of the most sensitive SIM data, i.e. keys stored on the SIM card. This functionality has not been developed, since there is a strong reluctance from the operators to allow sending key data OTA.

There exist technology today that generates keys on the card, but this technology has weaknesses. The resulting key information is not predictable, and some or all of the key information needs to sent or reported in order to be used.

The operators don't want to risk that the information sent OTA is somehow decrypted, and the sensitive information, mainly keys, may be copied.

The present invention enables remote management of the keys on SIM cards, without sending any sensitive information OTA.

With this ability, the operator may safely and remotely manage key's that are used for subscription definition. This ability allows operators to support new remote subscription activation, management and deactivation processes while optimizing SIM card logistics in a new efficient manner.

They can change all the data, including the sensitive keys, on the card to match the requirements from the external environment/application, e.g. the GSM network.

Today SIM card contains applications for receiving information OTA from a central OTA system according to GSM standard 03.48. This standard includes transport encryption of the data that protects the transmission and secures that only the intended recipient will be able to unpack the request. After receiving the OTA data, over a GSM network with a mobile terminal Me, i.e. a mobile telephone, the OTA application on the SIM card is capable of modifying the content, such as a key, on the card.

At present this is not possible with the known techniques due to the fact that there is a risk that OTA transmitted data is intercepted and copied, or that a third party may execute OTA that modifies the card to a desired state, i.e. make a “clone”.

Even though there is encryption and authentication in place in the OTA process, the operators has so far chosen not to send sensitive information, i.e. keys, OTA. At the same time there is an increasing demand to improve the remote manage-ability of SIM cards for future applications like Machine-to-machine, and on-demand-activation (ODA).

The present invention solves the problem of security mentioned above.

Thus, the present invention refers to a method of remote managing on-card generation of keys on SIM cards from a central OTA system, which OTA system has information about the identity of the SIM card, a first key KO stored on the SIM card, which first key is not readable from the SIM card, and a key generation algorithm stored on the SIM card, and is characterized in, that the central OTA system is caused to generate a piece of data D by means of a first algorithm D=f(K0,K1), where K1 is a key that shall be stored on the SIM card, in that the data D is transferred to the SIM card with OTA technology, in that an application on the SIM card is caused to make a calculation according to a second algorithm K1=F(K0,D) to generate the desired key K1 and in that K1 is stored on the SIM card.

Below the present invention will be described in a more specific way partly by means of exemplifying embodiments of the invention.

The present invention thus refers to a method of remote managing on-card generation of keys on SIM cards from a central OTA system. The OTA system is a part of a network for mobile communication, which network is operated by an operator.

The OTA system has information about the identity of the SIM card and a first key K0 stored on the SIM card, which first key is not readable from the SIM card. The first key K0 is secret. Further, the OTA system has information about a key generation algorithm stored on the SIM card having said identity.

According to the invention the central OTA system is caused to generate a piece of data D by means of a first algorithm D=f(K0,K1), where K1 is a key that shall be stored on the SIM card. The data D is after said generation transferred to the SIM card with OTA (Over the Air) technology and D is stored on the SIM card. Thereafter an application on the SIM card is caused to make a calculation according to a second algorithm K1=F(K0,D) to generate the desired key K1. Finally K1 is stored on the SIM card.

Since the key K0 is stored on the SIM card and is secret there is no possibility for a person to find out what effect the data D will have on the operation of the SIM card.

According to a highly preferred embodiment of the invention the result of said generation, key K1, is stored on the SIM card in a “write-only” manner. Thus the security level is the same for K1 as it is for K0.

According to one embodiment of the invention said piece of data D is a numeral, for example a numeral between 1 and 100 000 000 000 000 000.

According to an alternative embodiment of the invention the said piece of data D is an alphanumerical code, for example a letter between A and J, or a combination of a letter and a numeral.

According to a preferred embodiment the SIM card is caused to select a numerical value out of a number of values stored on the SIM card based on the received piece of data D. Such selected number is then used for said calculation carried out by means of the said second algorithm, generating the second key K1.

According to an alternative embodiment of the invention said numeral or said alphanumerical code is caused to select an algorithm out of a number of algorithms stored on the SIM card and in that the selected algorithm is said second algorithm. In this case the parameters inserted into the algorithm can be fixed and stored on the SIM card or the parameters can be transferred to the SIM card using OTA technology.

According to yet another embodiment of the present invention the SIM on-card key generation application cannot be read from the SIM card or the mobile terminal (ME).

According to still another embodiment the on-card key generation algorithm is caused to use a selected K0 from a selection of a number of K0 's stored on the card, where the used K0 is selected based on information in D.

According to an alternative embodiment the on-card key generation algorithm is caused to use a selected K0 from a selection of a number of K0 's stored on the card, where the used K0 is selected based on information from an application on the card.

Above a number of embodiments have been described. However, it is apparent that the said piece of data which is transferred to the SIM card with OTA technology can have any structure as long as it can be interpreted by the application on the SIM card.

Therefore, the present invention shall not be restricted to the embodiments given above, but can be varied within the scope of the attached claims.

1. Method of remote managing on-card generation of keys on SIM cards from a central OTA system, which OTA system has information about the identity of the SIM card, a first key K0 stored on the SIM card, which first key is not readable from the SIM card, and a key generation algorithm stored on the SIM card, characterised in, that the central OTA system is caused to generate a piece of data D by means of an first algorithm D=f(K0,K1), where K1 is a key that shall be stored on the SIM card, in that the data D is transferred to the SIM card with OTA technology, in that an application on the SIM card is caused to make a calculation according to a second algorithm K1=F(K0,D) to generate the desired key K1 and in that K1 is stored on the SIM card.

2. Method according to claim 1, characterised in, that the result of generation, key K1, is stored on the SIM card in a “write-only” manner.

3. Method according to claim 1, characterised in, that said piece of data D is a numeral.

4. Method according to claim 1, characterised in, that said piece of data D is an alphanumerical code.

5. Method according to claim 3, characterised in, that said numeral or said alphanumerical code is caused to select a numerical value out of a number of values stored on the SIM card.

6. Method according to claim 4, characterised in, that said numeral or said alphanumerical code is caused to select an algorithm out of a number of algorithms stored on the SIM card and in that the selected algorithm is said second algorithm.

7. Method according to claim 1, characterised in, that the on-card key generation application cannot be read from the SIM card or the mobile terminal (ME).

8. Method according to claim 1, characterised in, that the on-card key generation algorithm is caused to use a selected K0 from a selection of a number of K0's stored on the card, where the used K0 is selected based on information in D.

9. Method according to claim 1, characterised in, that the on-card key generation algorithm is caused to use a selected K0 from a selection of a number of K0's stored on the card, where the used K0 is selected based on information from an application on the card.

10. Method according to claim 2, characterised in, that said piece of data D is a numeral.

11. Method according to claim 2, characterised in, that said piece of data D is an alphanumerical code.

12. Method according to claim 4, characterised in, that said numeral or said alphanumerical code is caused to select a numerical value out of a number of values stored on the SIM card.
